(19) United States
(12) Patent Application Publication
(10) Pub. No.: US 2022/0269962 A1
(43) Pub. Date: Aug. 25, 2022

(54) ESTIMATING DEVICE, ESTIMATING METHOD, AND ESTIMATING PROGRAM

(71) Applicant: NIPPON TELEGRAPH AND TELEPHONE CORPORATION, Tokyo (JP)

(72) Inventors: Yasunori AKAGI, Tokyo (JP); Takuya NISHIMURA, Tokyo (JP); Takeshi KURASHIMA, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/627,601

(22) PCT Filed: Jul. 16, 2019
(86) PCT No.: PCT/JP2019/027970

§ 371 Date: Jan. 14, 2022

(51) Int. Cl. G06N 7/00

(52) U.S. Cl. CPC G06N 7/005

(57) ABSTRACT

A device estimates a number of people moving between the areas of people by building a problem based on a population in each of areas at each of time points and a probability of movement between predetermined areas in a directed graph. The directed graph includes vertices that correspond to the areas and edges that correspond to movement paths between the areas. A cost function for each edge determined from the probability of movement satisfies a constraint of discrete convexity representing a monotonous increase in change of a function value. The device estimates the number of people moving by computing the problem using a predetermined algorithm and estimating a probability of movement between the areas at each of the time points by minimizing a cost for the problem. The device repeats the estimating until satisfying a predetermined condition.

### TECHNICAL FIELD

The technique disclosed herein relates to an estimation device, an estimation method, and an estimation program.

### BACKGROUND ART

Human location information obtained from GPS or the like may be provided as time-specific area population data for populations existing in areas at different times where individuals are not allowed to be tracked due to privacy concerns. Here, the time-specific area population data is information on the number of people in each area at each time step (time point). The area is assumed to be a geospatial space divided into a grid, for example. There is a need to estimate the number of people moving between areas at each time point from such time-specific area population data.

As a conventional art, there is known a technique of using a framework (collective graphic model) for estimating individual probabilistic models from aggregated data to estimate the probability and the number of people moving between areas from time-specific area population data while taking into account the characteristics of each area or the distance between the areas (see NPL 1).

### CITATION LIST

### Non Patent Literature

[NPL 1] D. R. Sheldon and T. G. Dietterich. Collective Graphical Models. In Proceedings of the 24th International Conference on Neural Information Processing Systems, pp. 1161-1169, 2011

### SUMMARY OF THE INVENTION

### Technical Problem

However, the technique disclosed in NPL 1 has two problems. The first problem is related to the amount of computation. In the conventional art, it is necessary to solve a convex optimization problem having a large number of variables for optimization, resulting in taking much time to compute. In particular, the number of conditions around zero for the objective function becomes very large. Therefore, when the solution is likely to be sparse for, for example, a large number of areas, the amount of computation becomes very large.

The second problem is related to the setting of parameters. In the existing technology, for the convex optimization problem, it is necessary to determine the parameter λ for controlling the penalty, and the accuracy greatly differs depending on the setting of the parameter λ. However, since the convex optimization problem is a setting of unsupervised estimation, it is difficult to use a method of, for example, cross-validation, and there is no effective means for determining the parameter λ.

An object of the present disclosure is to provide an estimation device, an estimation method, and an estimation program capable of estimating the number of people moving between areas at each time point with high speed and high accuracy.

### Means for Solving the Problem

A first aspect of the present disclosure is an estimation device, including: a problem building unit that builds a problem for estimating, from a population in each of areas at each of time points and a probability of movement between predetermined areas in a directed graph represented by vertices corresponding to the areas and edges corresponding to movement paths between the areas, the number of people moving between the areas, so that a cost function for each edge determined from the probability of movement satisfies a constraint of discrete convexity representing a monotonous increase in change of a function value; a moving people number estimation unit that computes the problem by a predetermined algorithm to estimate the number of people moving between the areas at each of the time points; a movement probability estimation unit that estimates, based on the estimated number of people moving between the areas at each of the time points, a probability of movement between the areas such that a cost for the problem is minimized; and an estimation control unit that repeats building the problem, estimating the number of people moving, and estimating the probability of movement until a predetermined condition is satisfied, wherein the problem building unit builds the problem from the population in each of the areas at each of the time points and the estimated probability of movement between the areas in the repeating.

A second aspect of the present disclosure is an estimation method, including: building a problem for estimating, from a population in each of areas at each of time points and a probability of movement between predetermined areas in a directed graph represented by vertices corresponding to the areas and edges corresponding to movement paths between the areas, the number of people moving between the areas, so that a cost function for each edge determined from the probability of movement satisfies a constraint of discrete convexity representing a monotonous increase in change of a function value; computing the problem by a predetermined algorithm to estimate the number of people moving between the areas at each of the time points; estimating, based on the estimated number of people moving between the areas at each of the time points, a probability of movement between the areas such that a cost for the problem is minimized; and repeating building the problem, estimating the number of people moving, and estimating the probability of movement until a predetermined condition is satisfied, wherein the problem is built from the population in each of the areas at each of the time points and the estimated probability of movement between the areas in the repeating.

A third aspect of the present disclosure is an estimation program, causing a computer to execute: building a problem for estimating, from a population in each of areas at each of time points and a probability of movement between predetermined areas in a directed graph represented by vertices corresponding to the areas and edges corresponding to movement paths between the areas, the number of people moving between the areas, so that a cost function for each edge determined from the probability of movement satisfies a constraint of discrete convexity representing a monotonous increase in change of a function value; computing the problem by a predetermined algorithm to estimate the number of people moving between the areas at each of the time points; estimating, based on the estimated number of people moving between the areas at each of the time points, a probability of movement between the areas such that a cost for the problem is minimized; and repeating building the problem, estimating the number of people moving, and estimating the probability of movement until a predetermined condition is satisfied, wherein the problem is built from the population in each of the areas at each of the time points and the estimated probability of movement between the areas in the repeating.

### Effects of the Invention

According to the technique disclosed herein, it is possible to estimate the number of people moving between areas at each time point at high speed and with high accuracy.

### BRIEF DESCRIPTION OF DRAWINGS

FIG. 1 is a block diagram illustrating a configuration of an estimation device according to an embodiment of the present disclosure.

FIG. 2 is a block diagram illustrating a hardware configuration of the estimation device.

FIG. 3 illustrates an example of time-specific area population data which is stored in a population data storage unit.

FIG. 4 illustrates an example of a formulation of the minimum cost flow problem.

FIG. 5 illustrates an example of the estimated number of people moving between areas at each time point.

FIG. 6 illustrates an example of the estimated probability of movement between areas.

FIG. 7 is a flowchart illustrating the flow of estimation processing performed by the estimation device.

### DESCRIPTION OF EMBODIMENTS

An embodiment example of the disclosed technique will be described below with reference to the drawings. Note that the same reference numerals are given to the same or equivalent components and parts throughout the drawings. Further, the dimensional ratios in the drawings are exaggerated for convenience of explanation and may differ from the actual ratios.

First, the principle of the convex optimization problem, which is the premise in the present disclosure, will be described.

In the technique of the present disclosure, a likelihood function L(M, θ) is computed from the number of people Mₜᵢⱼ moving from an area i to an area j from a time t to a time t+1 and a probability of movement θᵢⱼ from the area i to the area j. The likelihood function L(M, θ) is maximized by moving M and θ under the conservation constraint for the number of people to perform estimation. For the description of the likelihood function L(M, θ), symbols are defined as follows.

For a natural number k, [k]:={1, . . . , k}. V is a set of the entire area. T is the maximum value of the time step. That is, the time step is t=1, . . . , T. G=(V, E) is an undirected graph representing adjacency between areas. Here, Γᵢ is a set of movement candidate areas from the area i. The population in the area i at the time t is represented by Nₜᵢ (t∈[T], i∈V). The number of people moved from the area i to the area j from the time t to the time t+1 is represented by Mₜᵢⱼ (t∈[T−1], i, j∈V).

Assume that the probability of movement from the area i to the area j is defined as θᵢⱼ, the number of people moving from the area i at the time t Mₜᵢ={Mₜᵢⱼ|j∈V} is generated using a probability of movement θᵢ={θᵢⱼ|j∈Γᵢ} from the area i at the time t by a probability represented in the following Equation (1).

$$[ Formula 1 ]$$

$$P ( {M}_{ti} \vert {N}_{ti} , {θ}_{i} ) = \frac{{N}_{ti} !}{{\prod }_{j ∈ {Γ}_{i}} {M}_{tij} !} {\prod }_{j ∈ {Γ}_{i}} {θ}_{ij}^{{M}_{tij}} \qquad ( 1 )$$

Therefore, given N={Nₜᵢ|t=0, . . . , T−1, i∈V}, θ={θᵢ|i∈V}, then the likelihood function for M={Mₜᵢ|t∈[T−1], i∈V} is as the following Equation (2).

$$[ Formula 2 ]$$

$$P ( M \vert N , θ ) = {\prod }_{t ∈ [ T - 1 ]}^{} {\prod }_{i ∈ V} ( \frac{{N}_{ti} !}{{\prod }_{j ∈ {Γ}_{i}} {M}_{tij} !} {\prod }_{j ∈ {Γ}_{i}} {θ}_{ij}^{{M}_{tij}} ) \qquad ( 2 )$$

Further, constraints expressing the conservation law for the number of people is satisfied by the following Equations (3) and (4).

$$[ Formula 3 ]$$

$${N}_{ti} = {\sum }_{j ∈ {Γ}_{i}} {M}_{tij} ( t ∈ [ T - 1 ] , i ∈ V ) \qquad ( 3 )$$

$${N}_{t + 1 , i} = {\sum }_{j ∈ {Γ}_{i}} {M}_{tji} ( t ∈ [ T - 1 ] , i ∈ V ) \qquad ( 4 )$$

Under Equations (3) and (4), which are the constraints, the following negative log-likelihood function is minimized to perform estimation.

$$[ Formula 4 ]$$

$$\begin{matrix}- log P ( M \vert N , θ ) = - {\sum }_{i ∈ [ T - 1 ]} {\sum }_{i ∈ V} ( log {N}_{ti} ! - {\sum }_{j ∈ {Γ}_{i}} log {M}_{tij} ! + {\sum }_{j ∈ {Γ}_{i}} {M}_{tij} log {θ}_{ij} \\ = {\sum }_{i ∈ [ T - 1 ]} {\sum }_{i ∈ V} {\sum }_{j ∈ {Γ}_{i}} ( log {M}_{tij} ! - {M}_{tij} log {θ}_{ij} ) + const .\end{matrix} ) \qquad ( 5 )$$

That is, the optimization problem to be solved is the following Equations (6a) to (6f).

$$[ Formula 5 ]$$

$${minimize}_{M , θ} {\sum }_{i ∈ [ T - 1 ]} {\sum }_{i ∈ V} {\sum }_{j ∈ {Γ}_{i}} ( log {M}_{tij} ! - {M}_{tij} log {θ}_{ij} ) , \qquad ( 6 a )$$

$$subject to {N}_{ti} = {\sum }_{j ∈ {Γ}_{i}} {M}_{tij} ( t = 0 , 1 , … , T - 2 ) , \qquad ( 6 b )$$

$${N}_{t + 1 , i} = {\sum }_{j ∈ {Γ}_{i}} {M}_{tji} ( t ∈ [ T - 1 ] , i ∈ V ) \qquad ( 6 c )$$

$${\sum }_{j ∈ {Γ}_{i}} {θ}_{ij} = 1 ( t ∈ [ T - 1 ] , i ∈ V ) \qquad ( 6 d )$$

$$0 \leq {θ}_{ij} \leq 1 ( i , j ∈ V ) \qquad ( 6 e )$$

$${M}_{tij} ∈ {ℤ}_{\geq 0} \qquad ( 6 f )$$

Here, Z_{≥0} (Z represents a set of real numbers expressed by an outlined character, the same applies hereinafter) is a set of all integers of 0 or more. The likelihood function (M, θ) is minimized by the alternating minimization for M and θ.

First, continuous relaxation is performed for M, and then by applying Stirling's approximation to the term of log Mₜᵢⱼ! to transform the objective function as represented in the following Equation (7), the minimization is performed for M.

$$[ Formula 6 ]$$

$${\sum }_{t ∈ [ T - 1 ]} {\sum }_{i ∈ V} {\sum }_{j ∈ {Γ}_{i}} ( {M}_{tij} log {M}_{tij} - {M}_{tij} - {M}_{tij} log {θ}_{ij} ) \qquad ( 7 )$$

Further, the objective function is incorporated as represented in the following Equation (8) with the conservation constraints (6b) and (6c) for the number of people as penalties.

$$[ Formula 7 ]$$

$${\sum }_{t ∈ [ T - 1 ]} {\sum }_{i ∈ V} {\sum }_{j ∈ {Γ}_{i}} ( {M}_{tij} log {M}_{tij} - {M}_{tij} - {M}_{tij} log {θ}_{ij} ) - \frac{λ}{2} \cdot {\sum }_{t ∈ [ T - 1 ]} {\sum }_{i ∈ V} {( {N}_{ii} - {\sum }_{j ∈ {Γ}_{i}} {M}_{tij} )}^{2} - \frac{λ}{2} \cdot {\sum }_{t ∈ [ T - 1 ]} {\sum }_{i ∈ V} {( {N}_{t + 1 , i} - {\sum }_{j ∈ {Γ}_{i}} {M}_{tji} )}^{2} \qquad ( 8 )$$

Here, λ is a parameter for controlling the penalties. This objective function is minimized under the constraint of Mₜᵢⱼ≥0. Since this is a convex programming problem, a global optimal solution can be obtained by a method of, for example, the L-BFGS-B. The maximization for θ is performed by using Lagrange's method of undetermined multiplier(s) or the like.

The respective embodiments will be described below based on the above principle. According to the respective embodiments of the present disclosure, M can be optimized at high speed by using the algorithm of the convex cost minimum cost flow problem. This makes it possible to provide very high speed estimation as a whole. Further, the amount of computation is no longer depending on the sparsity of the solution, and the number of moving people can be estimated with a stable amount of computation. In addition, the conservation constraint for the number of people is not incorporated into the objective function as a penalty term, but can be handled as the constraint, so that it is possible to estimate the number of moving people without determining the value of the hyperparameter λ.

### First Embodiment

The configuration of a first embodiment will be described below.

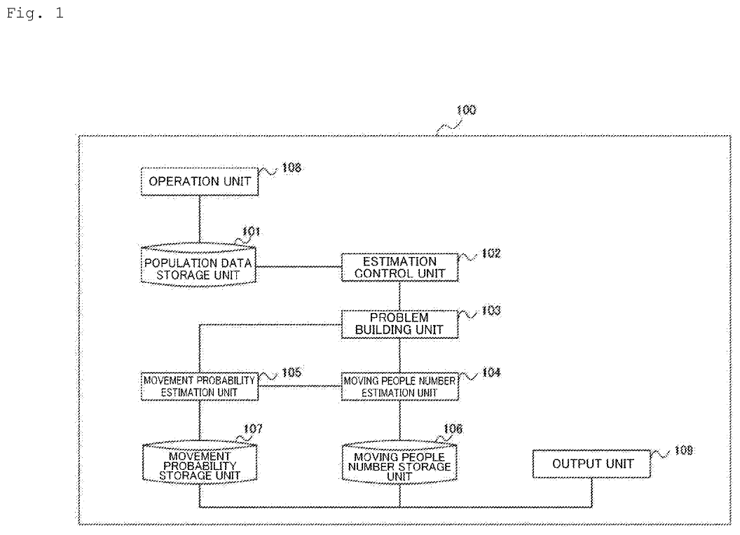

FIG. 1 is a block diagram illustrating a configuration of an estimation device according to the present embodiment.

As illustrated in FIG. 1, an estimation device 100 includes an estimation control unit 102, a problem building unit 103, a moving people number estimation unit 104, a movement probability estimation unit 105, an operation unit 108, and an output unit 109. Further, the estimation device 100 includes a population data storage unit 101, a moving people number storage unit 106, and a movement probability storage unit 107.

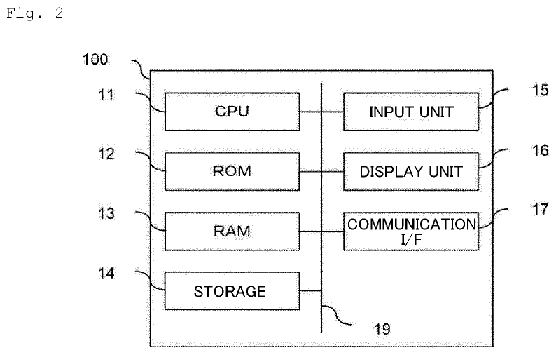

FIG. 2 is a block diagram illustrating an example of a hardware configuration of the estimation device 100.

As illustrated in FIG. 2, the estimation device 100 includes a CPU (Central Processing Unit) 11, a ROM (Read Only Memory) 12, a RAM (Random Access Memory) 13, a storage 14, an input unit 15, a display unit 16, and a communication interface (I/F) 17. The respective components are communicably connected to each other via a bus 19.

The CPU 11, which is a central arithmetic processing unit, executes various types of programs and controls each component. Specifically, the CPU 11 reads a program from the ROM 12 or the storage 14, and executes the program using the RAM 13 as a work area. The CPU 11 controls each of the above-mentioned components and performs various types of arithmetic processing in accordance with the program stored in the ROM 12 or the storage 14. In the present embodiment, an estimation program is stored in the ROM 12 or the storage 14.

The ROM 12 stores various types of programs and various types of data. The RAM 13 serves as a work area to temporarily store programs or data. The storage 14 is composed of an HDD (Hard Disk Drive) or SSD (Solid State Drive) to store various types of programs including an operating system, and various types of data.

The input unit 15 includes a pointing device such as a mouse and a keyboard, and is used for performing various types of inputs.

The display unit 16 is, for example, a liquid crystal display and displays various types of information. The display unit 16 may adopt a touch panel type to function as the input unit 15.

The communication interface 17 is an interface for communicating with other devices such as terminals, and uses, for example, standards such as Ethernet (registered trademark), FDDI, and Wi-Fi (registered trademark).

Next, each functional configuration of the estimation device 100 will be described. Each functional component is realized by the CPU 11 reading the estimation program stored in the ROM 12 or the storage 14, loading the estimation program into the RAM 13, and executing the estimation program.

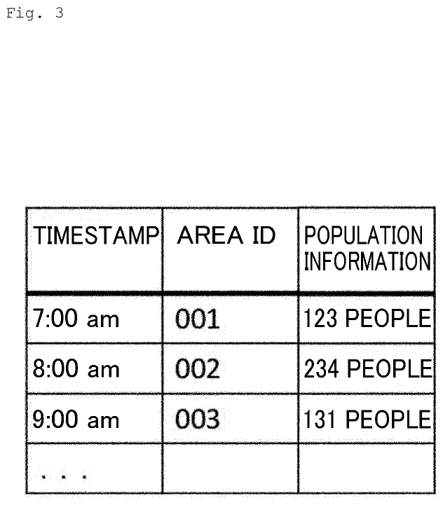

The population data storage unit 101 stores time-specific area population data which is data on a population in each area at each time point, reads the time-specific area population data in response to a request from the estimation device 100, and outputs the data to the estimation control unit 102. The time-specific area population data represents population information for each area and each time point which is referred to as a time step. The time step is an hourly time of day, such as 7:00 am, 8:00 am, and 9:00 am, and the area is, for example, a section obtained by dividing a geospatial space into a square grid of 5 km square. The population in an area i at a time t is represented by Nₜᵢ. FIG. 3 is a diagram illustrating an example of the time-specific area population data stored in the population data storage unit 101.

The estimation control unit 102 reads the time-specific area population data from the population data storage unit 101 and outputs the data to the problem building unit 103. Further, the estimation control unit 102 causes the moving people number estimation unit 104 to repeat estimating the number of moving people and causes the movement probability estimation unit 105 to repeat estimating the probability of movement until a predetermined condition is satisfied. Every time the execution of the movement probability estimation unit 105 is completed, the estimation control unit 102 checks whether a condition is satisfied, that is, whether or not the estimation is completed. As the condition, a method of confirming whether or not the likelihood has converged, a method of ending the estimation when a specified number of iterations are completed, and the like can be given.

The problem building unit 103 reads the probability of movement between predetermined areas from the movement probability storage unit 107. The probability of movement to be read is an initial value of the probability of movement between areas at the first time of repetition, and the estimated probability of movement between areas from the second time of repetition onwards. The problem building unit 103 builds a problem for estimating the number of people moving between areas based on the time-specific area population data and the probability of moving between the predetermined areas. This problem is called the so-called convex cost minimum cost flow problem (hereinafter, also simply referred to as the problem) . The problem to be built by the problem building unit 103 is built, in a directed graph represented by vertices corresponding to the areas and edges corresponding to movement paths between the areas, so that a cost function for each edge determined from the probability of movement satisfies a constraint of discrete convexity representing a monotonous increase in change of a function value. The specific procedure for building the problem will be described below.

First, the minimum cost flow problem for solving the convex cost minimum cost flow problem will be described. The non-linear minimum cost flow problem is a problem for minimizing the cost by the following directed graph. A directed graph G=(V, E) is given as input, and each edge (i, j)∈E is assigned a capacity constraint uᵢⱼ∈Z_{≥0} and a cost function cᵢⱼ: Z_{≥0}→R (R is a set of real numbers expressed by an outlined character). Further, each vertex i∈V is given a demand bᵢ∈Z_{≥0}. The minimum cost flow problem is a problem of finding an edge with the lowest cost in a flow that satisfies the capacity constraint for each edge and the demand constraint for each vertex. Defining the flow for edge (i, j)∈E as xᵢⱼ, this minimum cost flow problem can be formulated as in the following Equation (9).

$$[ Formula 8 ]$$

$${min}_{x ∈ {ℤ}^{\vert E \vert}} \cdot {\sum }_{( i , j ) ∈ E} {c}_{ij} ( {x}_{ij} ) , \qquad ( 9 )$$

$$s . t . {\sum }_{j : ( i , j ) ∈ E} {x}_{ij} - {\sum }_{j : ( j , i ) ∈ E} {x}_{ji} = {b}_{i} ( i ∈ V ) ,$$

$$0 \leq {x}_{ij} \leq {u}_{ij} ( ( i , j ) ∈ E ) .$$

Equation (9) of the non-linear minimum cost flow problem of the above form is generally NP-hard, and it is difficult to design an efficient algorithm. However, depending on the form of the cost function cᵢⱼ, an optimal solution can be efficiently obtained. The most common case is when the cost function cᵢⱼ is a linear function, and various efficient solutions have been proposed. As a broader class problem that can be solved more efficiently, there is a problem that holds for any edge (i, j)∈E in which a discrete convexity of cᵢⱼ(x+1)+cᵢⱼ(x−1)≥2·cᵢⱼ(x) (x=1, 2, . . . , ) is satisfied. The discrete convexity represents a property in which a change in the function value increases monotonically. This problem is called the convex cost minimum cost flow problem.

Return now to the problem of minimization for M. In view of the above-mentioned convex cost minimum cost flow problem, when updating M, the optimization problem of the following Equation (10) can be solved independently for t∈[T−2].

$$[ Formula 9 ]$$

$${min}_{{M}_{t}} \cdot {\sum }_{i ∈ V} {\sum }_{j ∈ {Γ}_{i}} ( log {M}_{tij} ! - {M}_{tij} log {θ}_{ij} ) , \qquad ( 10 )$$

$$s . t . {N}_{ti} = {\sum }_{j ∈ {Γ}_{i}} {M}_{tij} ( i ∈ V ) ,$$

$${N}_{t + 1 , i} = {\sum }_{j ∈ {Γ}_{i}} {M}_{tji} ( i ∈ V ) ,$$

$${M}_{tij} ∈ {ℤ}_{\geq 0} ( i ∈ V , j ∈ {Γ}_{i} ) .$$

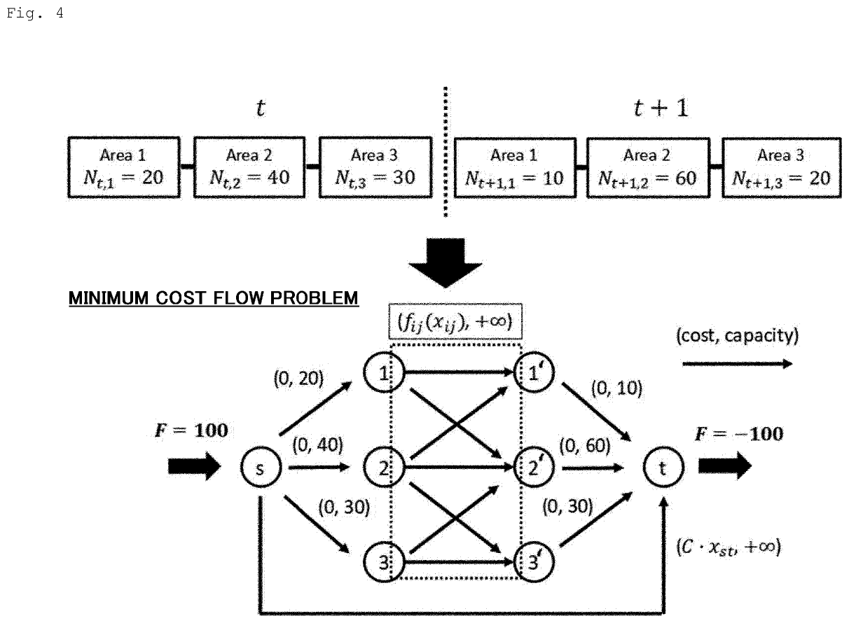

A method of formulating Equation (10) , which is the convex cost minimum cost flow problem, as the minimum cost flow problem of Equation (9) will be described. FIG. 4 is a diagram illustrating an example of the formulation of the minimum cost flow problem. First, a set of vertices for constructing a directed graph is represented by V′={s, t, 1, 2, . . . , n, 1′, 2′, . . . , n′}. Here, s is the start point of the vertices, and t is the end point of the vertices. And, with respect to this set of vertices V′, edges are drawn as the following 1 to 4.

1. Draw an edge from a vertex s to a vertex i (i=1, 2, . . . , n). For each edge, the cost function is 0, and the capacity is Nₜᵢ. The cost function is a constant function.

2. Draw an edge from a vertex i′ (i=1, 2, . . . , n) to a vertex t. For each edge, the cost function is 0, and the capacity is N_{t+1,i}. The cost function is a constant function.
3. Draw an edge from a vertex i (i=1,2, . . . , n) to a vertex j′ (j∈Γᵢ). Here, the cost function is set considering that it is determined according to the probability of movement. Setting the cost function to be determined according to the probability of movement in this way makes it possible to solve a problem of estimating the number of people moving between areas by adopting the solution of the convex cost minimum cost flow problem. Specifically, each cost function is fᵢⱼ(x): =log x!−x·log θᵢⱼ, and the capacity is +∞.
4. Draw an edge from a vertex s to a vertex t. The cost function is C·xₛₜ using a sufficiently large positive constant C, and the capacity is +∞.

As described in above 3., in the problem, the cost function for each edge is determined from the probability of movement θᵢⱼ between areas. Accordingly, since the probability of movement θᵢⱼ between the areas is updated in the repetition by the estimation control unit 102, a problem is built so that the cost function of each edge is determined by the currently estimated probability of movement θᵢⱼ between the areas.

Further, F is defined. Set F: =max {Σ_{i∈V}Nₜᵢ, Σ_{i∈V}N_{t+1,i}}, and bₛ=F, bₜ=−F, bᵢ=bᵢ′=0 (i∈[n]).

If there is a feasible solution in Equation (10) for the original problem, then it is found that for an optimal solution x* for the minimum cost flow problem formulated here and for the optimal solution Mₜ* of Equation (10) for the original problem, the relation of Mₜⱼᵢ*=xᵢⱼ′* (i∈V, j∈Γᵢ) holds. Therefore, if this minimum cost flow problem is solved, Equation (10) for the original problem can also be solved. Furthermore, even if there is no feasible solution in Equation (10) for the original problem, an appropriate flow is applied to an edge (s, t) to compensate for that, so that the formulated minimum cost flow problem always has a feasible solution.

Here, the following property hold for a cost function fᵢⱼ for edge. That is, fᵢⱼ(x):=log x!−x·log θᵢⱼ (i∈V, j∈Γᵢ) satisfies the following Equation (11).

$$[ Formula 10 ]$$

$${f}_{ij} ( x + 1 ) + {f}_{ij} ( x - 1 ) \geq 2 \cdot {f}_{ij} ( x ) ( x = 1 , 2 , … ) \qquad ( 11 )$$

$$Proof :$$

$${f}_{ij} ( x + 1 ) + {f}_{ij} ( x - 1 ) - 2 \cdot {f}_{ij} ( x ) = \{ log ( x + 1 ) ! + log ( x + 1 ) ! - 2 \cdot log x ! \} - \{ ( x + 1 ) + ( x - 1 ) - 2 \cdot x \} = log ( x + 1 ) - log x \geq 0$$

In the formulated minimum cost flow problem, since the cost function is a constant function, a linear function, or an fᵢⱼ, all the cost functions satisfy the discrete convexity representing a monotonous increase in change of the function value. Accordingly, the problem that satisfies the constraint of fᵢⱼ as the cost function fᵢⱼ can be replaced with the minimum cost flow problem. The constrained cost function fᵢⱼ can be solved by replacing it with the cost function cᵢⱼ in Equation (9). Therefore, the convex cost minimum cost flow problem can be replaced with the minimum cost flow problem to be solved, and thus an optimal solution can be efficiently obtained. The replacement with the above constraints and minimum cost flow problem makes it possible for the problem building unit 103 to build the problem so that the cost function in the directed graph satisfies the constraint of discrete convexity.

The moving people number estimation unit 104 computes the problem built by the problem building unit 103 by a predetermined algorithm, estimates the number of people moving between areas at each time point, and stores the resulting number of people in the moving people number storage unit 106. In the present embodiment, an algorithm called the successive shortest path method for searching for the shortest path to a vertex that satisfies the condition is used. The successive shortest path method is one of the solutions for the minimum cost flow problem. The moving people number estimation unit 104 solves the problem by using the successive shortest path method, and stores the resulting solution as the estimated number of people moving between areas in the moving people number storage unit 106. Specifically, the moving people number estimation unit 104 constructs an auxiliary graph called a residual graph for the minimum cost flow problem. The moving people number estimation unit 104 repeats an operation of searching for the shortest path to a vertex j where bᵢ−(Σ_{j:(i,j)∈E}xᵢⱼ−Σ_{j:(j,i)∈E}xⱼᵢ)<0 in the residual graph and applying the flow along the shortest path. In a simple implementation, it is necessary to consider edges with negative cost in finding the shortest path, so that it is necessary to use the Bellman-Ford method, which is low speed. However, if the update is repeated while holding the value defined for each vertex, which is called the potential, in the algorithm, the Dijkstra method, which is high speed, can be applied in the shortest path search. When the Dijkstra method is implemented using a binary heap, the amount of computation in the successive shortest path method is O (F·n²log n). For details of the algorithm, refer to Section 14.3 in Reference 1.

[Reference 1] R. K. Ahuja, T. L. Magnanti, J. B. Orlin, Network Flows: Theory, Algorithms, Applications, Prentice Hall, 1993.

The movement probability estimation unit 105 reads the currently estimated number of people moving between areas from the moving people number storage unit 106, and based on the read number of people moving between areas, estimates a probability of movement between the areas so that the cost in the problem is minimized, and stores the resulting probability in the movement probability storage unit 107. The specific procedure will be described below.

Taking the logarithm of a likelihood P(M|N, θ), the following Equation (12) is obtained.

$$[ Formula 11 ]$$

$$\begin{matrix}log P ( M \vert N , θ ) = {\sum }_{i ∈ [ T - 1 ]} {\sum }_{i ∈ V} ( log {N}_{ti} ! - {\sum }_{j ∈ {Γ}_{i}} log {M}_{tij} ! + {\sum }_{j ∈ {Γ}_{i}} {M}_{tij} log {θ}_{ij} ) \\ = {\sum }_{i ∈ [ T - 1 ]} {\sum }_{i ∈ V} {\sum }_{j ∈ {Γ}_{i}} {M}_{tij} log {θ}_{ij} + const .\end{matrix} \qquad ( 12 )$$

Note that, in the last line, parts other than those that depend on θ are simply expressed as “const”. Here, log P(M|N, θ) can be maximized under the following constraint.

$$[ Formula 12 ]$$

$${\sum }_{j ∈ {Γ}_{i}} {θ}_{ij} = 1 ( i ∈ V ) , 0 \leq {θ}_{ij} \leq 1 ( i , j ∈ V )$$

Such θ* can be expressed in the closed form of the following Equation (13) by using Lagrange's method of undetermined multiplier(s).

$$[ Formula 13 ]$$

$${θ}_{ij}^{*} = \frac{{\sum }_{t ∈ [ T - 1 ]} {M}_{tij}}{{\sum }_{t ∈ [ T - 1 ]} {\sum }_{k ∈ {Γ}_{i}} {M}_{tik}} \qquad ( 13 )$$

The operation unit 108 receives various types of operations on the time-specific area population data in the population data storage unit 101. The various types of operations are operations for registering, modifying, or deleting the time-specific area population data.

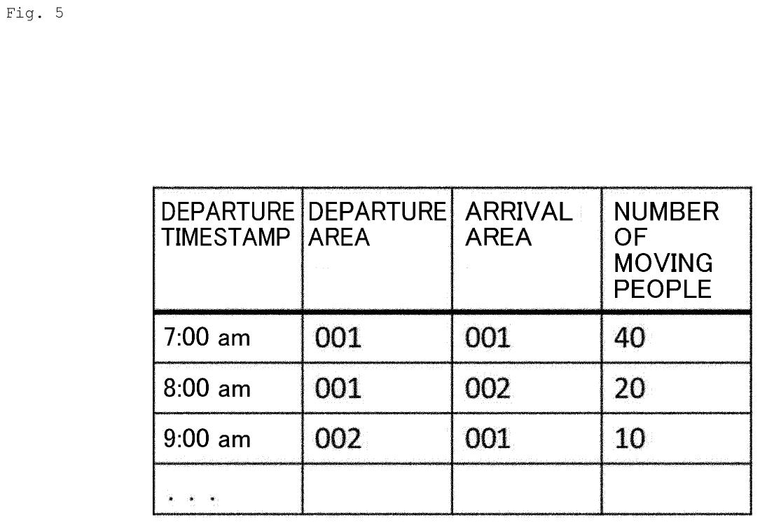

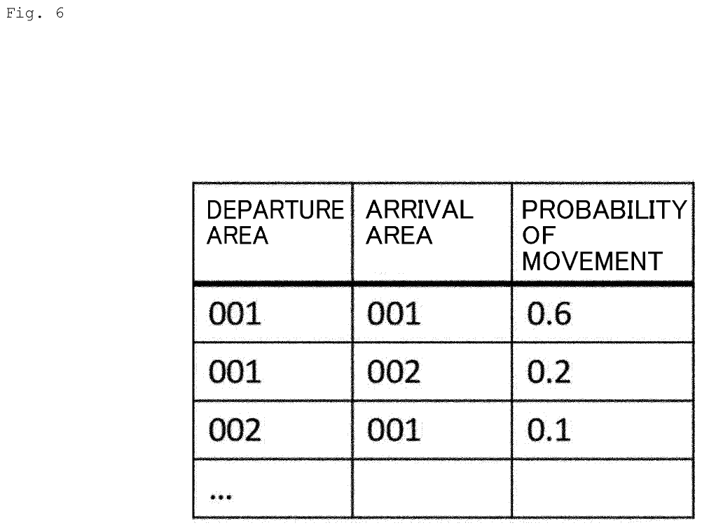

The output unit 109 reads the number of people moving between areas at each time point stored in the moving people number storage unit 106 and the probability of movement between areas stored in the movement probability storage unit 107, and outputs them to the outside as an estimation result. FIG. 5 illustrates an example of the estimated number of people moving between areas at each time point. FIG. 6 illustrates an example of the estimated probability of movement between areas.

Next, an operation of the estimation device 100 will be described.

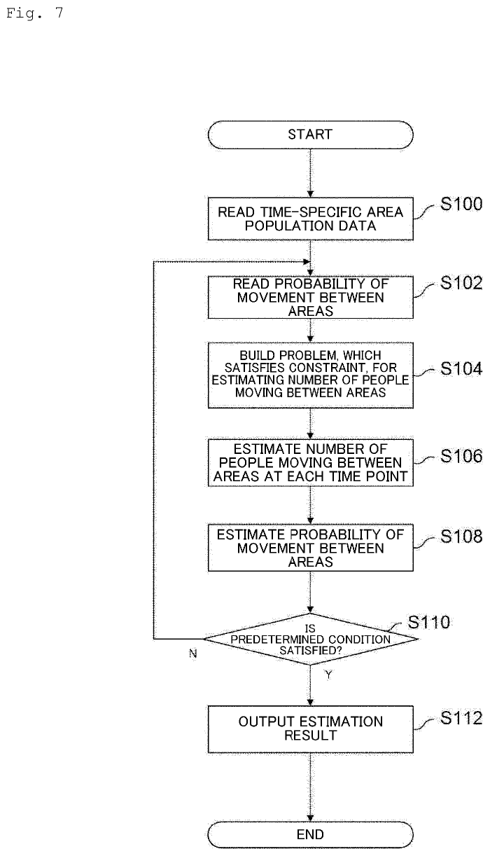

FIG. 7 is a flowchart illustrating the flow of estimation processing performed by the estimation device 100. The estimation processing is performed by the CPU 11 reading the estimation program from the ROM 12 or the storage 14, loading the estimation program into the RAM 13, and executing the estimation program.

In step S100, the CPU 11 reads the time-specific area population data.

In step S102, the CPU 11 reads the probability of movement between predetermined areas from the movement probability storage unit 107. The probability of movement to be read is an initial value of the probability of movement between areas at the first time of repetition, and the estimated probability of movement between areas from the second time of repetition onwards.

In step S104, the CPU 11 builds a problem, which satisfies the constraints, for estimating the number of people moving between areas, based on the time-specific area population data read in step S100 and the probability of movement between the predetermined areas read in step S102. The problem to be built is built, in a directed graph represented by vertices corresponding to the areas and edges corresponding to movement paths between the areas, so that a cost function for each edge determined from the probability of movement satisfies a constraint of discrete convexity representing a monotonous increase in change of a function value. The problem is built so as to satisfy the constraint expressed by Equation (11) and replace the problem of Equation (10) with Equation (9).

In step S106, the CPU 11 computes the problem built in step S104 by a predetermined algorithm, estimates the number of people moving between areas at each time point, and stores the resulting number of people in the moving people number storage unit 106.

In step S108, the CPU 11 reads the currently estimated number of people moving between areas from the moving people number storage unit 106. The CPU 11 estimates a probability of movement between areas based on the read number of people moving between areas so that the cost in the problem is minimized, and stores the resulting probability of movement in the movement probability storage unit 107.

In step S110, the CPU 11 determines whether or not the predetermined condition is satisfied. If the condition is satisfied, the processing in the CPU 11 proceeds to step S112, and if the condition is not satisfied, the processing in the CPU 11 returns to step S102 to repeat the processing.

In step S112, the CPU 11 reads the number of people moving between areas at each time point stored in the moving people number storage unit 106 and the probability of movement between areas stored in the movement probability storage unit 107, and outputs them to the outside as an estimation result.

As described above, according to the estimation device 100 of the present embodiment, it is possible to estimate the number of people moving between areas at each time point at high speed and high accuracy.

### Second Embodiment

A second embodiment is different from the first embodiment in that the algorithm of the successive shortest path method used in the moving people number estimation unit 104 is replaced with the capacity scaling method, but is the same in the configuration and operation. Accordingly, only the moving people number estimation unit 104 will be described.

The moving people number estimation unit 104 solves the convex cost minimum cost flow problem built by the problem building unit 103 by using an algorithm called the capacity scaling method, and stores the resulting solution as the estimated number of moving people in the moving people number storage unit 106. The capacity scaling method is one of the solutions for the minimum cost flow problem. The successive shortest path method has a disadvantage that the amount of computation is proportional to F. For area-specific population data on areas where the total population is large, F becomes very large, resulting in taking too much time to compute in the successive shortest path method. The capacity scaling method is a method that improves this point, and the amount of computation is O (log F·n⁴log n). As a specific procedure, the moving people number estimation unit 104 first takes Δ such that 2^{Δ}≥F, and constructs a Δ residual graph. As described above, the capacity scaling method has a constraint on the capacity F at a vertex as the start point. Then, the moving people number estimation unit 104 repeats the operation of performing the shortest path search in the same manner as in the successive shortest path method to apply a flow by Δ along the shortest path. The moving people number estimation unit 104 multiplies Δ by ½ when the flow cannot apply any more, and returns to the start. The moving people number estimation unit 104 repeats this, and ends the algorithm when the phase of Δ=1 is completed. For details of the algorithm of the capacity scaling method, refer to Section 14.4 in Reference 1.

As described above, according to the estimation device 100 of the present embodiment, it is possible to estimate the number of people moving between areas at each time point at high speed and high accuracy.

Note that in the above embodiments, various types of processors other than the CPU may execute the estimation processing executed by the CPU reading the software (program). Examples of the processors in this case include PLD (Programmable Logic Device) whose circuitry is reconfigurable after manufacturing, such as FPGA (Field-Programmable Gate Array), a dedicated electric circuit, which is a processor having circuitry specially designed for performing specific processing, such as ASIC (Application Specific Integrated Circuit), and the like. Further, the estimation processing may be executed by one of these various types of processors, or a combination of two or more processors of the same type or different types (e.g., a plurality of FPGAs and a combination of a CPU and an FPGA, etc.). Further, the hardware configuration of these various types of processors is, more specifically, an electric circuit in which circuit elements such as semiconductor elements are combined.

Further, in the above embodiment, an aspect has been described in which the estimation program is previously stored (installed) in the storage 14. However, the present invention is not limited to this. The program may be provided in the form of being stored in a non-transitory storage medium such as CD-ROM (Compact Disk Read Only Memory), DVD-ROM (Digital Versatile Disk Read Only Memory), and USB (Universal Serial Bus). Further, the program may be in the form of being downloaded from an external device via a network.

The following Notes will be further disclosed with respect to the above embodiments.

### Note 1

An estimation device comprising:

a memory; and

at least one processor connected to the memory,

wherein the processor is configured to:

build a problem for estimating, from a population in each of areas at each of time points and a probability of movement between predetermined areas in a directed graph represented by vertices corresponding to the areas and edges corresponding to movement paths between the areas, the number of people moving between the areas, so that a cost function for each edge determined from the probability of movement satisfies a constraint of discrete convexity representing a monotonous increase in change of a function value;

compute the problem by a predetermined algorithm to estimate the number of people moving between the areas at each of the time points;

estimate, based on the estimated number of people moving between the areas at each of the time points, a probability of movement between the areas such that a cost for the problem is minimized; and

repeat building the problem, estimating the number of people moving, and estimating the probability of movement until a predetermined condition is satisfied,

wherein the problem is built from the population in each of the areas at each of the time points and the estimated probability of movement between the areas in the repeating.

### Note 2

A non-transitory storage medium that stores an estimation program causing a computer to execute:

building a problem for estimating, from a population in each of areas at each of time points and a probability of movement between predetermined areas in a directed graph represented by vertices corresponding to the areas and edges corresponding to movement paths between the areas, the number of people moving between the areas, so that a cost function for each edge determined from the probability of movement satisfies a constraint of discrete convexity representing a monotonous increase in change of a function value;

computing the problem by a predetermined algorithm to estimate the number of people moving between the areas at each of the time points;

estimating, based on the estimated number of people moving between the areas at each of the time points, a probability of movement between the areas such that a cost for the problem is minimized; and

repeating building the problem, estimating the number of people moving, and estimating the probability of movement until a predetermined condition is satisfied,

wherein the problem is built from the population in each of the areas at each of the time points and the estimated probability of movement between the areas in the repeating.

### REFERENCE SIGNS LIST

100 Estimation device
101 Population data storage unit
102 Estimation control unit
103 Problem building unit
104 Moving people number estimation unit
105 Movement probability estimation unit
106 Moving people number storage unit
107 Movement probability storage unit
108 Operation unit
109 Output unit

1. An estimation device, comprising circuitry configured to execute a method comprising:
building a problem for estimating, from a population in each of areas at each of time points and a probability of movement between predetermined areas in a directed graph represented by vertices corresponding to the areas and edges corresponding to movement paths between the areas, the number of people moving between the areas, so that a cost function for each edge determined from the probability of movement satisfies a constraint of discrete convexity representing a monotonous increase in change of a function value;
computing the problem by a predetermined algorithm to estimate the number of people moving between the areas at each of the time points;
estimating, based on the estimated number of people moving between the areas at each of the time points, a probability of movement between the areas such that a cost for the problem is minimized; and
repeating building the problem, estimating the number of people moving, and estimating the probability of movement until a predetermined condition is satisfied,
wherein the building the problem is based on the population in each of the areas at each of the time points and the estimated probability of movement between the areas in the repeating.

2. The estimation device according to claim 1, wherein the estimating a probability of movement uses a successive shortest path method for searching for a shortest path to a vertex that satisfies a condition, or a capacity scaling method that satisfies a constraint on a capacity of the vertex as a start point.

3. A computer-implemented method for estimating, comprising:
building a problem for estimating, from a population in each of areas at each of time points and a probability of movement between predetermined areas in a directed graph represented by vertices corresponding to the areas and edges corresponding to movement paths between the areas, the number of people moving between the areas, so that a cost function for each edge determined from the probability of movement satisfies a constraint of discrete convexity representing a monotonous increase in change of a function value;
computing the problem by a predetermined algorithm to estimate the number of people moving between the areas at each of the time points;
estimating, based on the estimated number of people moving between the areas at each of the time points, a probability of movement between the areas such that a cost for the problem is minimized; and
repeating building the problem, estimating the number of people moving, and estimating the probability of movement until a predetermined condition is satisfied,
wherein the problem is built from the population in each of the areas at each of the time points and the estimated probability of movement between the areas in the repeating.

4. The computer-implemented method according to claim 3, wherein, as the predetermined algorithm, a successive shortest path method for searching for a shortest path to a vertex that satisfies a condition, or a capacity scaling method that satisfies a constraint on a capacity of the vertex as a start point, is used.

5. A computer-readable non-transitory recording medium storing computer-executable program instructions that when executed by a processor cause a computer system to execute a method comprising:
building a problem for estimating, from a population in each of areas at each of time points and a probability of movement between predetermined areas in a directed graph represented by vertices corresponding to the areas and edges corresponding to movement paths between the areas, the number of people moving between the areas, so that a cost function for each edge determined from the probability of movement satisfies a constraint of discrete convexity representing a monotonous increase in change of a function value;
computing the problem by a predetermined algorithm to estimate the number of people moving between the areas at each of the time points;
estimating, based on the estimated number of people moving between the areas at each of the time points, a probability of movement between the areas such that a cost for the problem is minimized; and
repeating building the problem, estimating the number of people moving, and estimating the probability of movement until a predetermined condition is satisfied,
wherein the problem is built from the population in each of the areas at each of the time points and the estimated probability of movement between the areas in the repeating.

6. The estimation device according to claim 1, wherein the problem includes a convex cost minimum cost flow problem.

7. The estimation device according to claim 2, wherein the problem includes a convex cost minimum cost flow problem.

8. The computer-implemented method according to claim 3, wherein the problem includes a convex cost minimum cost flow problem.

9. The computer-implemented method according to claim 4, wherein the problem includes a convex cost minimum cost flow problem.

10. The computer-readable non-transitory recording medium according to claim 5, wherein the estimating a probability of movement uses a successive shortest path method for searching for a shortest path to a vertex that satisfies a condition, or a capacity scaling method that satisfies a constraint on a capacity of the vertex as a start point.

11. The computer-readable non-transitory recording medium according to claim 5, wherein the problem includes a convex cost minimum cost flow problem.

12. The computer-readable non-transitory recording medium according to claim 10, wherein the problem includes a convex cost minimum cost flow problem.
